(19) United States
(12) Patent Application Publication
(10) Pub. No.: US 2006/0071603 A1
(43) Pub. Date: Apr. 6, 2006

(54) Ultra high luminance (UHL) lamp with SCA envelope

(76) Inventor: Maurice E. Levis, Hallieford, VA (US)

Correspondence Address: BOWMAN,GREEN,HAMPTON & KELLY, PLLC;ATTN: PETER A. SHADDOCK, 501 INDEPENDENCE PARKWAY, SUITE 201, CHESAPEAKE, VA, 23320, US

(21) Appl. No.: 10/958,454

(22) Filed: Oct. 4, 2004

(51) Int. Cl. H01J 61/18

(52) U.S. Cl. 313/638

(57) ABSTRACT

An Ultra High Luminance (UHL) high intensity discharge (HID) lamp is described. The lamp envelope is made of single crystal alumina (SCA) material. The fill consists mainly of mercury at densities in the range of 0.3 to 0.7 mg/mm³. The lamp is designed for applications in the projection field where small light modulation imaging devices are used. The lamp design includes a variety of burner (lamp vessel ) geometries and sealing arrangements. This lamp technology represents a major departure from the Ultra High Pressure (UHP) fused silica envelope, mercury filled, HID lamps that are currently used and overcomes the adverse effect of convection. The preferred, and described, alternative burner (vessel ) geometries are envelopes with non-uniform wall thickness, which are thicker at the tops and thinner at the bottoms; a bulbous shape which is more curved at the top than at the bottom; and placing the arc off the center axis, so that the arc is closer to the bottom than it is to the top. The vessel, preferably, is manufactured as a monolithic SCA crystal so that traditional end plugs are not needed.

### BACKGROUND OF THE INVENTION

During the last fifteen years business presentation image displays and image displays in general have shifted from the use of film and CRTs (Cathode Ray Tubes) to LCD (Liquid Crystal Display), DLP (Digital Light Processing) and LCOS (Liquid Crystal on Silicon) technologies. The new generation of imaging devices, sometimes referred to as light valves, is based on various approaches of light modulation by electronic controllers. As the new display industry matured with the use of so called light valve imaging, it has been driven by cost and projector size considerations to develop ever smaller light valves. The market demands smaller and cheaper projectors. At present there are some broad categories of sizes of LCD, DLP or LCOS light valves that have found niche applications in various market niches. There is a category of light valve sizes in the vicinity of 0.5″ diagonal; a second category is 0.7″ to 0.9″ diagonal; and a third category in the vicinity of 1.8″ diagonal. At the early history of this technology light valve sizes were in the range of 3.5″ to 10.4″ panels.

The light valve, in effect, replaces the film slide of a film based projector at the imaging aperture. The reduction in size of the light valves and as a result of imaging apertures over the years has presented a severe challenge to the projector lamp technology. In order to get sufficient light through the small imaging apertures for the purpose of generating bright images on the viewing screen, certain limiting conditions must apply to the lamp design. There is a well known relationship between the size of the aperture to be illuminated and the size of the emitting element of the projection lamp. The emitting element in an HID lamp is determined by the size of the arc gap. The efficiency of the transmission of light from a lamp, through an imaging aperture, to the screen can be determined using the optical invariant called the etendue (geometric extend). In fact, such projection systems are called etendue limited. Table I shows in broad terms the relationship of aperture size to arc gap size and the etendue that needs to be achieved for a variety of light valve based projection systems.

TABLE I

| ARC GAP | | ETENDUE | LIGHT VALVE DIAGONAL |
|---|---|---|---|
| 0.5-0.7 | mm | 5 mm²ster | 0.5″ LCD |
| 1.0 | mm | 13 mm²ster | 0.7″-0.9″ LCD, DLP |
| 1.3 | mm | 35 mm²ster | 1.8″ LCD, SXGA DLP |

These relationships are based on calculations and modeling of the optics as well as experimental confirmation and they are used for rough matching of lamps to apertures. Etendue figures are approximating effective “beam” etendue rather than lamp etendue. “Beam” etendue is measured and includes the aberrations contributed by the collection optics used with a projection lamp, such as elliptical reflectors and burner bulb distortions.

Until about 1995 the HID technology was such that most HID lamps that were bright enough to be used in projection had arc gaps in the range of 2.0 to 4.0 mm. Such arc gaps were sufficiently small to be used with the light valves of that period. As the imaging apertures became smaller, the net effect was that there was less light transmitted to the projection screen when using then state of the art lamps. Philips developed the high pressure mercury type UHP lamps in order to rectify this situation and help the new electronic imaging industry to the next level of performance. The UHP lamp was designed with the ability to maintain small arc gaps by virtue of the fact that its mercury fill operated at pressures over 200 bar as compared to operating pressures prevailing at the time in the vicinity of 50 bar. In the pre-1995 technology, it was necessary to operate at larger arc gaps in order to obtain sufficient amounts of light through an aperture with the result of highly inefficient transfer of the light from the lamp to the screen. As the gaps required became smaller, the lamp emitted appreciably less light and operated at a considerably reduced efficacy. The only way to compensate for this loss due to smaller gaps was to increase the luminance of the arc. This was done by increasing the operating pressure in the lamp. As the pressure of the mercury fill was increased the luminance increased. The plasma in the arc produced widely broadened spectral lines and much more continuum radiation thus enhancing the color spectrum and gaining in color efficiency. By going to higher lamp pressures it was possible to maintain a high voltage drop across the lamp arc gap thus maintaining, and in some occasions enhancing, lamp efficacy. The plasma temperature was also increased to provide a color temperature of 8,000° K which is considered desirable for image display in darkened rooms. As the UHP technology evolved during the last five years, lamp performance was improved until this technology recently reached the limits of its capability. The limits are imposed by the fused silica envelope of the UHP lamps. At this point the lamp has reached the fused silica limits regarding tensile strength and temperature tolerance. This means no further improvements are possible by raising the pressure or increasing the power to these lamps. The need by the projection industry for more light on the screen for its imaging products and the requirements to illuminate ever smaller imaging apertures is not as yet satisfied. There is a demand for lamps that go beyond the performance limits of current UHP lamps in terms of total light output, efficacy, arc gap size and color. It is not possible, for example, to operate a fused silica envelope UHP lamp with a desired gap of 0.5 mm without raising the operating lamp pressure substantially above 300 bar and still maintain the required luminance, voltage across the arc gap and long life.

Extensive lamp modeling of the high pressure mercury lamp indicates that higher mercury pressures are needed in order to extend the lamp performance to smaller arc gaps and higher efficacies. At present, the highest mercury fill pressures attainable for practical projection lamps with long life times is in the range of 250 bar. To increase the pressure one needs to increase both the temperature on the inside of the envelope of the lamp as well as the tensile strength of the envelope material. Table II shows the relationships with the tensile stress calculated for a cylindrical tube with circular cross-section, a 5 mm inside radius and a 2 mm wall.

TABLE II

| OPPERATING | INSIDE WALL | TENSILE STRESS |
|---|---|---|
| PRESSURE (bar) | TEMPERATURE (° C.) | (psi) |
| 200 | 902 | 7,500 |
| 250 | 946 | 9,375 |
| 300 | 993 | 11,250 |
| 400 | 1060 | 15,000 |
| 500 | 1117 | 18,750 |
| 600 | 1156 | 22,500 |
| 700 | 1197 | 26,250 |

The inside wall temperature of the burner bulb is dictated by the necessary mercury vapor pressure required to achieve the desired operating lamp pressure. All parts of the internal surface of the burner must be at or above that temperature in order to achieve the desired operating pressure.

TABLE III
SCA/PCA/QUARTZ COMPARISON

| | | Sapphire¹ | Alumina² | Fused |
|---|---|---|---|---|
| PROPERTIES | Units | SCA | PCA | Silica |
| Melting Point | ° C. | 2040 | 2000 | 1597 |
| Maximum Useful | ° C. | 1600 | 1600 | 1100 |
| Temperature | | | | |
| Thermal | W/cm° K | 0.100 | 0.070 | 0.014 |
| Conductivity | | | | |
| @ 1000° C. | | | | |
| Expansion | cm/cm/° K | 8.8 × 10⁻⁶ | 8.4 × 10⁻⁶ | 5.5 × 10⁻⁷ |
| Coefficient | | | | |
| @ 25-1100° C. | | | | |
| Tensile Strength | psi | 155000 | NA | 7000 |
| @25° C. | | | | |
| Max Transmittance | 1.0 = 100% | 0.98 | 0.84 | 0.94 |
| 0.3-0.9 nm (1.0 mm | | (clear) | (translucent) | (clear) |
| wall) | | | | |

¹Single crystal alumina
²Poly-crystalline alumina

TABLE IV
TENSILE STRENGTH OF SAPPHIRE AND FUSED SILICA

| Temperature | Sapphire | Fused Silica |
|---|---|---|
| ° C. | SCA (psi) | (psi) |
| 25 | 155,000 | 7,000 |
| 500 | 80,000 | 18,500 |
| 1000 | 73,000 | 24,000 |
| 1400 | 45,000 | FAILURE |
| 1600 | 30,000 | FAILURE |

FOR TUBES: Burst Pressure = (2 × Wall Thickness × Tensile Strength @ Temp)/ID

Tables III and IV are provided for the purpose of comparing the properties of fused silica and SCA materials. The substitution of a SCA envelope for the state of the art fused silica envelope allows the lamp to be operated at higher mercury pressures so that lamp performance can meet higher standards. It should be noted that that the tensile strength figures given for SCA tubes are nominal. In his book “Materials for Infrared Windows and Domes” Daniel C. Harris (SPIE Optical Engineering Press 1999) warns as follows: “It is dangerous to quote the strength of a material, since it depends on the type and quality of surface finish, material fabrication method, material purity, test method and specimen size”. This means that tensile strength figures for SCA materials are not an inherent property of the material but a result of the fabrication, quality of raw materials and finishing processes.

In order to obtain high operating pressures inside a lamp burner it is essential to achieve the temperature indicated by the mercury vapor pressure required for that particular pressure. Such temperatures are shown on Table II. The highest pressure UHP lamp claimed by Philips and now commercially available has an operating pressure of 250 bar. To maintain this pressure, the burner inside surface at any point needs to be at a temperature of no less than roughly 946° C. However, the maximum allowable burner temperature for the purpose of preventing devitrification of the fused silica wall (which would lead to the destruction of the fused silica vessel) is approximately 1100° C. This leaves a very narrow range of temperatures between the maximum allowable and the minimum required. This situation results in limiting the lamp from being loaded at higher power or being scaled to a larger burner vessel where the temperature constraint may be reduced. If the burner vessel size were to be scaled up then convection currents inside the burner would increase thus creating a large temperature difference between the lower part and the upper part of the vessel and the minimum temperature would be reduced as well. It should be noted that convection currents inside the burner increase with burner size and there always exists a difference in temperature between the bottom and the top of the burner. By “bottom” is meant the side toward the earth and “top” the side toward the sky, since convection is primarily due to gravity. Generally, UHP lamps are operated with the burner being horizontal. By keeping the burner size small one can reduce the convection currents and thereby reduce the difference in temperature between top and bottom. This temperature difference is kept small in the Philips lamp by virtue of keeping the burner small, so that the top temperature does not go over 1100° C. As pointed out earlier, this does not leave any options open for increasing the lamp performance either by going to higher pressure or higher power (higher power loading) for the same arc gap. This discussion follows the reasoning as developed initially by H. E. Fischer in U.S. Pat. No. 5,497,049

In order to achieve higher lamp powers, higher power loadings, smaller gaps and higher pressures in the burner one must replace the fused silica envelope with a material that can operate at higher temperatures, wall and power loadings and pressures. The material of choice according to this invention is sapphire (SCA).

For prior art which mentions or discusses the use of a single crystal alumina (SCA) sapphire envelope for a non-flash HID lamp, see U.S. Pat. Nos. 5,427,051; 5,540,182; 5,588,992; 6,566,817; 6,661,176 and 6,781,292. Also see four issued patents and one published patent application, all assigned to Gem Lighting LLC (“Gem”). They are: U.S. Pat. No. 6,414,436 (“'436 Patent”); U.S. Pat. No. 6,483,237 (“'237 Patent”); U.S. Pat. No. 6,652,344 (“'344 Patent”); U.S. Pat. No. 6,661,174 (“'174 Patent”) and Published Patent application 20040036393 (Ser. No. 10/460,688) (“'393 Application”). The present Inventor, Maurice Levis, has filed an Information Disclosure Statement in the '393 application relating to a cylindrical SCA burner from ILC of California.

### SUMMARY OF THE INVENTION

Convection, which is caused primarily by gravity, causes the burner (lamp envelope) of a HID lamp to be unevenly heated. The present invention proposes a number of ways, which may be applied alternatively or together, to overcome this problem of and provide a more even heating of the wall of the burner. In the first embodiment, the shape of the burner is changed to provide a greater curvature at the top than its curvature at the bottom. A cross-section taken perpendicular to the axis would show an asymmetric shape. In another embodiment the bottom wall is made thicker than the top wall. In still other embodiments, uneven heating is attempted to be overcome by placing the arc off center. The arc is away from the central axis of a symmetric burner. The arc is placed so that it is closer to the bottom wall than it is to the top wall. The prior art shows that the sealing of lamp envelopes (burners) may be a serious problem as the pressure within the lamps is raised, especially above 200 bar. The present invention seeks to solve the sealing problem by eliminating separate sealing plugs and forming the burner as a monolithic SCA crystal around the electrodes.

### BRIEF DESCRIPTION OF THE DRAWINGS

The following detailed description of the invention should be considered along with the accompanying drawings:

In the drawings:

FIG. 1 is a cross-sectional view of a prior art burner (lamp envelope);

FIG. 2 is a chart which plots minimum required inside burner temperature for a given mercury fill density required inside the burner;

FIG. 3 is a chart which plots voltage against mercury fill density for a number of sizes of arc gaps;

FIG. 4 is a chart which plots maximum burner area against minimum temperature required on the inside wall of the burner bulb;

FIGS. 5-9 are cross-sectional views, taken through the central axis (imaginary), of burners which are embodiments of the present invention, the burners being shown without their electrodes:

FIG. 10 is a view looking into the central axis and showing isothermal curves from the arc;

FIG. 11 is a cross-sectional view through the central axis of an asymmetric burner;

FIGS. 12-14 are cross-sectional views, taken perpendicular to the central axis, of three different designs of asymmetric burners; and

FIG. 15 is a cross-sectional view, taken perpendicular to the central axis, of a burner whose bottom wall thickness is thicker than its top wall.

### DETAILED DESCRIPTION OF THE INVENTION

1. General Considerations

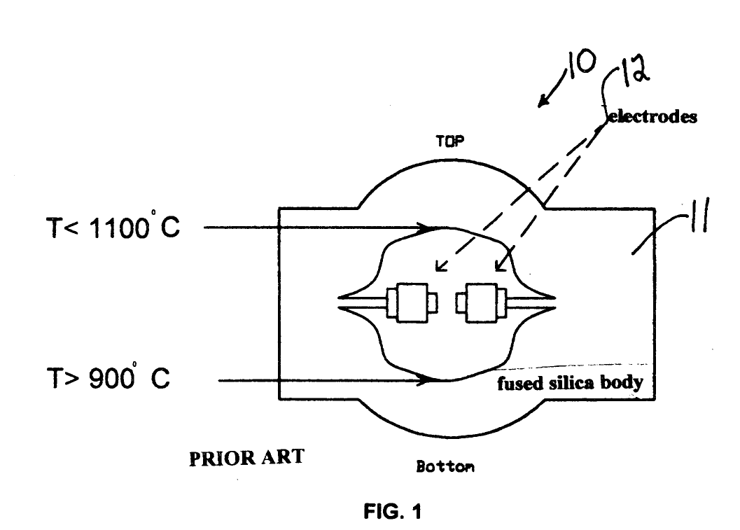

From the various considerations given above it becomes clear that the burner (lamp bulb) design is critical in providing the required temperatures for the proper operation of the arc lamp at high pressures. FIG. 1 provides a schematic diagram further illustrating the requirements. FIG. 1 is an outline of a burner 10 representing burner designs with electrodes 12 currently used in UHP/Philips lamps. In a fused silica body 11 the envelope upper temperature that can be tolerated without burner crystallization is approximately 1100° C. The temperature that must be maintained in order to produce the high mercury pressures desired is based on the temperature of the mercury vapor pressure at that pressure. At present UHP/Philips lamps can operate at bottom temperatures in the range of 900° C. to 950° C. to achieve operating pressures of 200 to 250 bar. The difference in temperature between the top and bottom of the burner vessel is due to convection currents that result in a temperature gradient between the bottom and the top of the burner rendering the top hotter than the bottom. Typical burner diameters from top to bottom for UHP lamps vary from about 4 mm to 7 mm depending on arc gap and power. Such diameters are selected based on considerations related to the convection effect that impacts the difference in temperature between the top and the bottom part of the burner. The key goal is to maintain the bottom hot enough to meet the required mercury vapor pressure and the top cool enough to prevent the fused silica envelope from crystallizing. The smaller the burner is the less the effect of convection currents is and the smaller the difference from the top and bottom temperatures. Such diameters are smaller than those that would be indicated if one were to consider only the Grashof number, which is an indicator of convective stability for the arc. The Grashof number is given by the following equation,
Gᵣ/c=π²×r³×(Hg density+other fill densities)² (1)

Where Gᵣ is the Grashof number, c is a constant, r is in mm and the fill densities are in mg/mm³. A criterion for convective stability is taken from Mathews et al (U.S. Pat. No. 5,239,230) and is,
Gᵣ/c<1.4 mg²/mm³ (2)

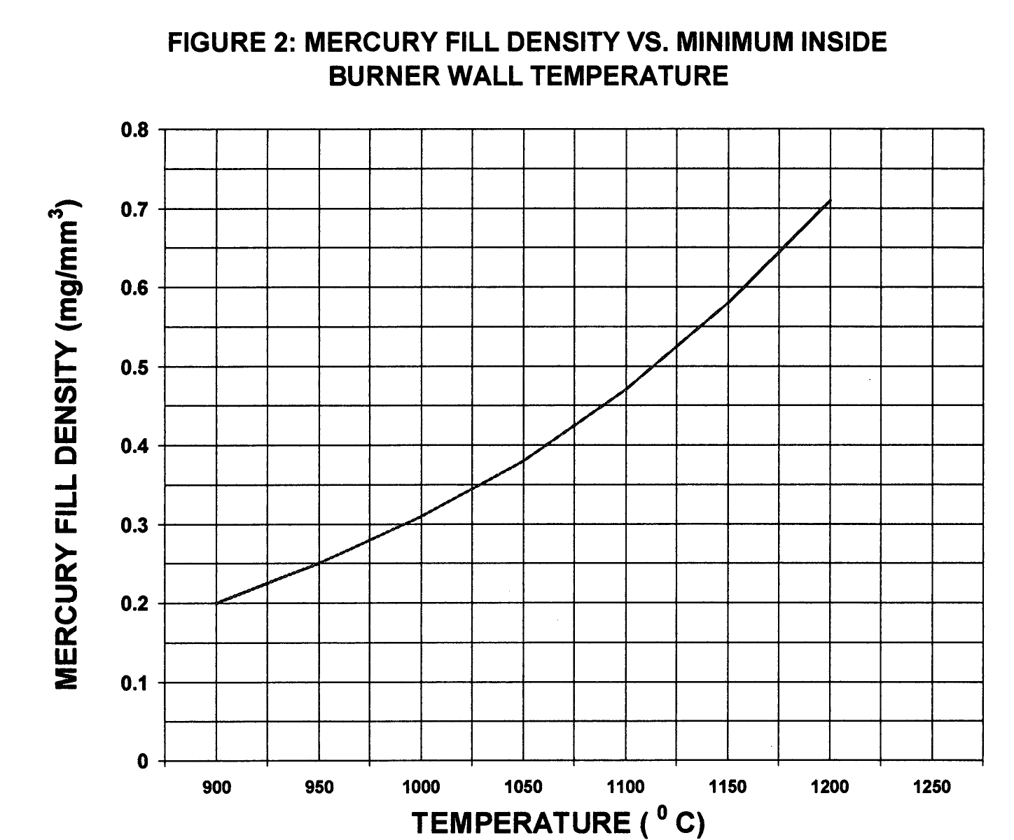

The preferred ranges for this invention of lamp operating mercury fill densities are approximately 0.300 to 0.750 mg/mm³. FIG. 2 is a chart indicating the minimum temperature required on the inside wall of the burner bulb for each value of mercury fill density used in order to operate the lamps of this invention at the proper burner pressures.

II. Voltage Considerations

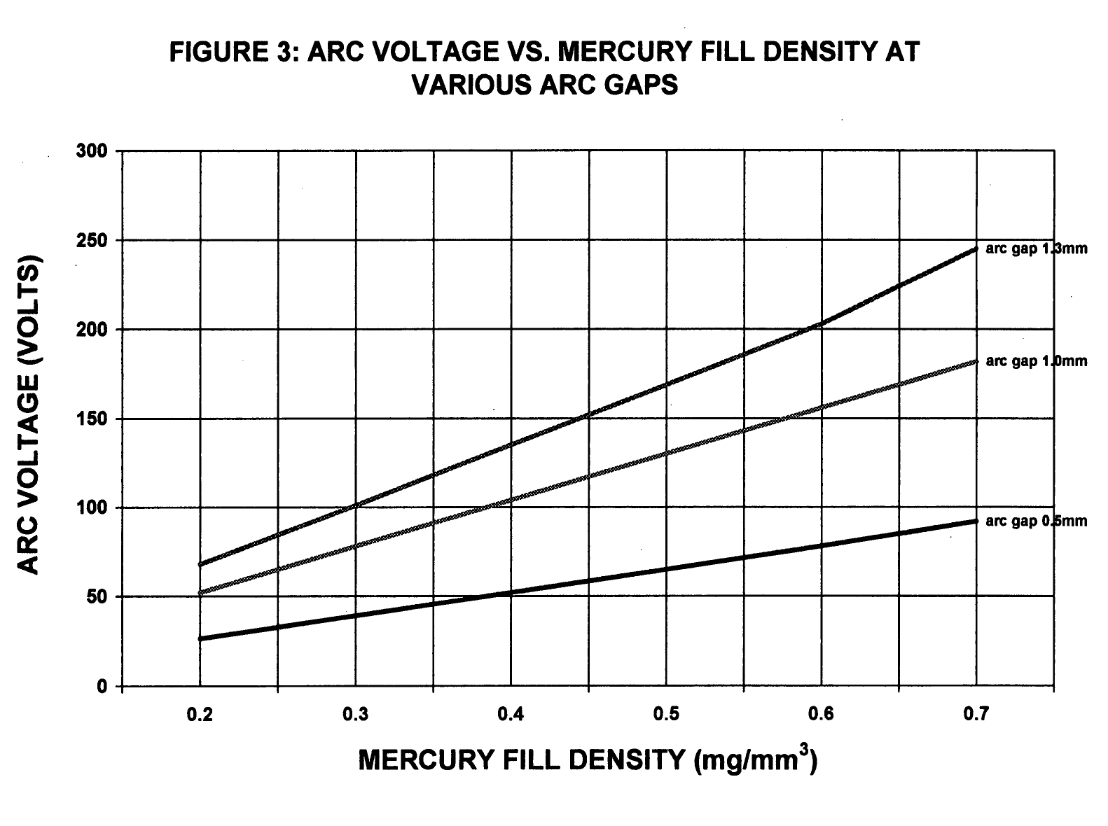

The preferred lamp needs to meet several criteria in order to operate in the range of parameters that this invention prefers. The lamp is designed to operate under mercury pressures between 300-750 bar with arc gaps in the range of 0.5 to 1.5 mm. It is important from the lamp efficacy point of view that the lamp operates with an appropriate voltage drop across the arc gap. Typically, one expects a voltage drop of 15 to 18 volts due to the electrodes. This power is lost to the arc and goes to heating the electrodes, also known as electrode drop. A parametric equation is given by Holger Moench in “UHP Lamps with Increased Efficiency” (SID Digest 2003) which describes the operating voltage of a UHP lamp as follows:
Vₗₐₘₚ=V_{elec}+V_{arc}=V_{elec}+a d p (3)
where the voltage drop at the electrodes V_{elec} is approximately 15 to 18 volts, d is the arc gap in mm, p the pressure in bar and a is a constant a=0.26 v/mm bar. A graph is shown in FIG. 3 depicting the variation of lamp voltage with arc gap and fill density.

The preferred range of arc gaps under this invention is 0.5 to 1.5 mm. At this time state of the art lamp pressures of up to 250 bar are achieved in UHP lamps of the Philips type. An increase in pressures from 250 bar to 500 or 600 bar will increase arc voltages for all gap categories substantially. This is particularly important in gap categories of 0.5 to 0.8 mm. It should be noted that in the graph of FIG. 3 the voltages indicated are the arc voltages. Operating voltages, which include the electrode drop, will be 15 to 18 volts higher. The overall lamp efficacy depends on the magnitude of the arc voltage as a multiple of the electrode drop voltage. The lamp efficacy is particularly sensitive to the effective arc voltage at the smaller gap sizes as a fraction of the lamp operating voltage. It can be seen that a lamp with a 0.5 mm gap operating at 250 bar will have an arc voltage of about 32 volts. The operating voltage for such a lamp would be about 50 volts.

The useful power would be only 64% of the lamp power. At an operating pressure of 600 bar the arc voltage would be 78 volts and the operating voltage 96 volts. The useful power would be 81% of the lamp power, an improvement in efficacy of 26%.

III. Thermal Modeling

The burner design is critical to the lamp performance at the pressure and temperature ranges that are proposed in this invention. An approximate technique is used here to predict the wall temperature of a burner and therefore determine the size of the burner that will yield the desired wall temperatures. For this analysis the Stefan-Boltzmann equation is used
P=εσT⁴ (4)

Where P is the radiant power in erg/cm² sec
ε is the total radiant emissivity
σ is the Stefan Boltzmann constant, 5.669×10⁻⁵ erg cm⁻²deg⁻⁴sec⁻¹

By solving this equation for a particular desired temperature one can obtain the total surface area required to emit this radiant power. This surface represents the outer wall surface area of the desired burner. Once the outside wall temperature is known, one can then calculate the difference in temperature between the outside wall and the inside wall using the following formula,
ΔT=qt/k (5)
where q is the heat flux in watts/cm²
t is the wall thickness
k is the thermal conductivity in watts/cm ° K

This calculation allows one to estimate the size of the desired burner and is, in fact, a fair approach in the thermal modeling of the burner. A certain fraction of the heat generated inside the burner (arc chamber) is transferred to the burner walls through mostly convection and conduction. For transparent materials such as fused quartz and SCA there are only insignificant contributions from radiative transfer to the walls. One needs to know that approximately 40% for fused silica and 30% for SCA of the power applied to an arc lamp of the type that is considered here gets transferred to the walls and then the walls radiate at the temperature they achieve as gray bodies. Also, the approximate emissivities of the materials used in the temperature range of interest must be known. For fused silica the emissivity used is 0.9. For SCA the total radiant emissivity is measured to be about 0.22 in the temperature range from 1,000 to 1200° K. This model is applied to the Philips type UHP. The burner is approximated by a sphere with 2.5 mm inside radius and 5.0 mm outside radius. The outside surface area of the sphere is 3.14 cm². The power input is 100 watts. Taking 40% of that flux gives one 40 watts spread over 3.14 cm² about 13 watts/cm². Using this value in the Stefan-Boltzmann equation and solving for the temperature one obtains about T=1263° K or 990° C. for the temperature of the outer wall. The wall is 2.5 mm thick and the fused quartz thermal conductivity is 0.0287 w/cm ° K. The Delta T is calculated to be 113° C., giving an inside wall temperature of 1103° C., which is the maximum temperature that can be used with fused quartz in order to avoid crystallization over time. It clearly indicates that the fused quartz burners used for the Philips type lamps are operating at the limits of their physical properties. This approach to modeling burners does not account for the convection effect where the top of the burner is normally hotter than the bottom. In the Philips type lamps it is estimated that the top burner temperature is about 200° C. hotter than the bottom, thus indicating that the top is at about 1100° C. and the bottom at about 900° C., the right temperature to support a mercury vapor pressure of about 200 bar, the operating pressure claimed by Philips. It should be noted that the inside shape of the Philips burner is not spherical in shape but more like two confluent cones joined at the edges, like FIG. 1 indicates. The actual shape of the burner is a tool for designing and achieving the thermal models that are desired for lamp operation.

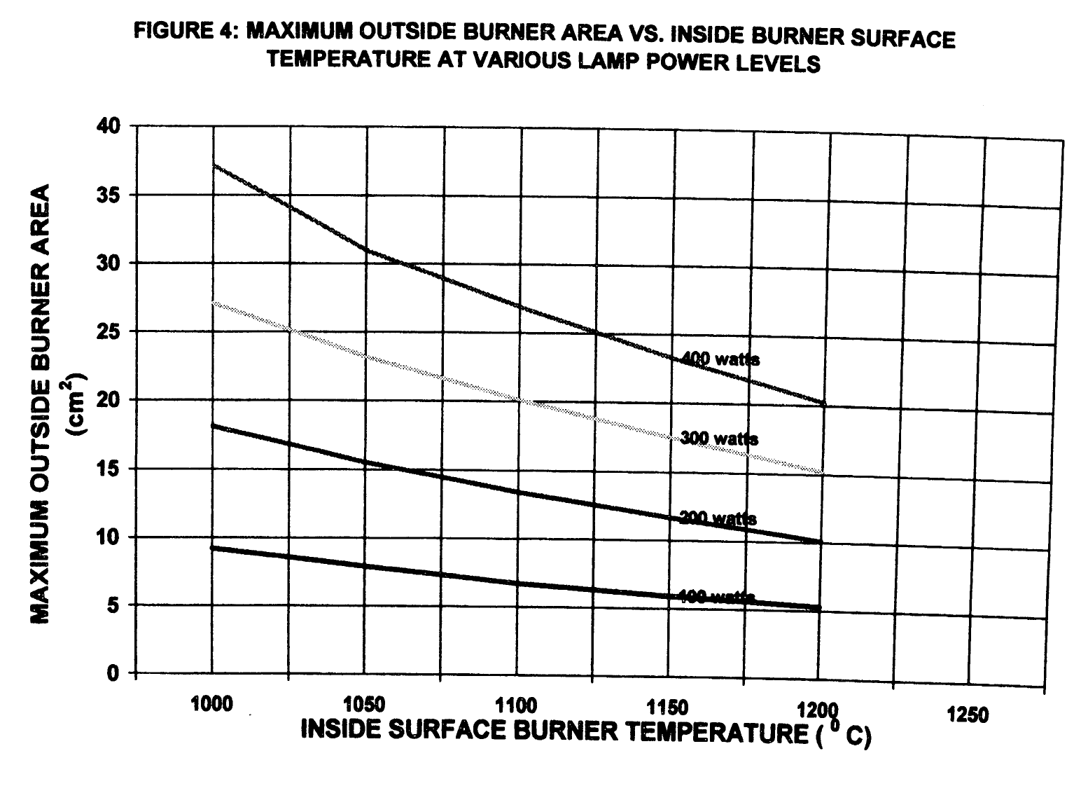

In order to achieve the appropriate inside wall temperature for a lamp whose envelope is fabricated with SCA material the same approach is followed as shown above for the thermal analysis of the fused quartz envelope lamp. It is assumed that 30% of the total power into the arc lamp is transferred by convection and conduction to the envelope. The envelope than comes to a thermal equilibrium with the outside by emitting radiant flux at the same rate. In this manner, since the desired outer wall temperature is known, the resulting radiant flux can be calculated and the maximum desired outer surface value for the burner can be established. FIG. 4 is a chart indicating the maximum desired burner outer surface value for lamp powers from 100 W to 300 W for the purpose of meeting the minimum required temperature for the inside wall of the burner bulb.

The difference in temperature between the inside wall of the burner, which is hotter, and the outside wall of the burner is quite small for SCA burners because of the high SCA conductivity, which is almost ten times that of fused silica. The value used here for the SCA conductivity is 0.105 watts/cm ° K. The temperature difference is about 13° C. for an outer wall temperature of 1,000° C. and about 23° C. for an outer wall temperature of 1,200° C. It should be noted that when considering two burners of the same shape and size one made of fused silica and one of SCA material and an arc lamp operating at the same lamp power, the SCA burner surface will get hotter than the fused silica surface because the SCA emissivity is about 25% of that of fused silica at temperatures in the range of 1,000 to 1,2000° C. It should also be noted that at a given burner temperature the heat flux from a SCA burner will be 25% that of a fused silica burner with the same surface area.

In the burner pressure range of 300 to 750 bar the wall thickness is considered in a cylindrical geometry. The tensile strength of SCA can be such, depending on fabrication and finishing methods that a 1 mm wall thickness can be used with at least a safety factor of two and at the lower pressures. At the higher pressures one could use a wall thickness of 1.5, 2.0 or 2.5 mm if an extra margin of safety is desired. The areas for the maximum outside surface indicated in FIG. 4 can be translated into a variety of shapes. For example, if a spherical shape is selected for the burner, in the case of the 600 bar lamp at 100 W, a sphere of 6.9 mm outer radius would be indicated that would result in a surface area of 6.0 cm². If the shape of choice is cylindrical, a tube of 7 mm radius and 6 mm length would be close to the right dimensions for that shape yielding again a surface area close to that indicated for the 600 bar, 100 W lamp in FIG. 4. One can vary the burner shape to accommodate other than thermal considerations as long as the effective burner surface area is smaller than the maximum allowed for a particular operating pressure for a lamp. Indeed, using smaller then the maximum surface indicated would increase the temperature of the inside wall of the burner. When using SCA envelopes one has the latitude to go to higher burner temperatures without fear of damaging the envelope.

IV. Vessel (Burner) Design

It has been mentioned above that the shape of the burner (vessel) can be a design element in the lamp design. There are techniques at present for the fabrication of SCA lamp burners that have features that go beyond the straight tubular geometries commonly claimed in patents by Eastlund et al (U.S. Pat. Nos. 6,414,436; 6,661,174B2; 6,483,237; 6,652,344). In fact a recent technical review by P. I. Antonov and V. N. Kurbov titled “A review of developments in shaped crystal growth of sapphire by the Stepanov and related techniques” describes a number of up to date techniques for fabricating variable radius SCA shapes. This reference indicates that recent advances in crystal growth technology have resolved past problems related to the formation of gas bubbles and other inclusions. Earlier growth techniques of “near net shape” shapes of sapphire involved the EFG process (Edge defined, Film-fed, Growth). That process, however, suffers from the presence of bubbles and inclusions. A newer approach has been developed by V. N. Kurlov called the NCS process (Non-capillary Shaping Technique). The essential difference between the crystals grown by the NCS process and those produced by the EFG or VST (Variable Shaping Technique) technique is the absence of gas bubbles in the crystal volume. The NCS method allows the fabrication of crystals of various cross sections and variable diameters including the passage from a solid to a hollow geometry. The preferred method of fabrication for the SCA burners under this invention is the NCS process.

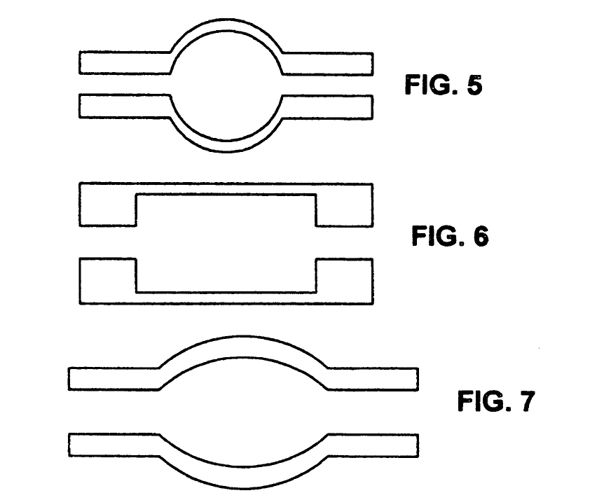

The ability to fabricate variable shapes of SCA burners affects a number of lamp parameters. Such parameters involve the burner convection patterns, the sealing geometry and the temperature of the burner inside and outside surfaces, in effect the burner surface area. A preferred geometry involves the fabrication of several shapes of monolithic burners. Monolithic refers to the geometry where the burner ends are shaped like plugs, which normally would have to be introduced into the tube ends. The difference here is that the burner ends are integrated into the burner shape, therefore the description “monolithic”. This makes it possible to introduce seals directly onto the burner body without requiring end plugs. FIGS. 5, 6 and 7 depict various configurations of monolithic SCA burners as cross-sections along the arc axis. FIG. 5 depicts an SCA monolithic burner with a generally spherical bulb shape. FIG. 6 depicts an SCA monolithic burner with generally a cylindrical shape. FIG. 7 depicts an SCA monolithic burner with a generally oval shape. FIG. 8 depicts a quasi cylindrical burner with curved transition shoulders. One could also fabricate monolithic SCA bulbs where the arms are completely sealed off. Such burner shapes could then be drilled along the arm to provide entry for the electrodes.

It should be recalled that the thermal equilibrium requirements for the burners relate to the surface area of the bulb. However, the arms on which the electrodes 14,15 are mounted can serve to conduct heat away as well. Lamp arm surfaces need to be considered in SCA lamp envelope designs when designing the lamp burner to meet the maximum area limits required by thermal balancing considerations. Extended lamp arm surfaces may reduce the bulb temperature below that required to obtain the proper mercury vapor pressure desired, one should therefore have means of reducing the heat flow along the arms of the burner. This can be done using “heat choke” techniques on the SCA material itself. For example, in FIG. 9, the cylindrical burner is depicted again but with a significant difference. Cuts 12,13 are made on the burner arms for the purpose of reducing heat flow out of the burners. “Heat chokes” can be used on the arms of burners of any shape.

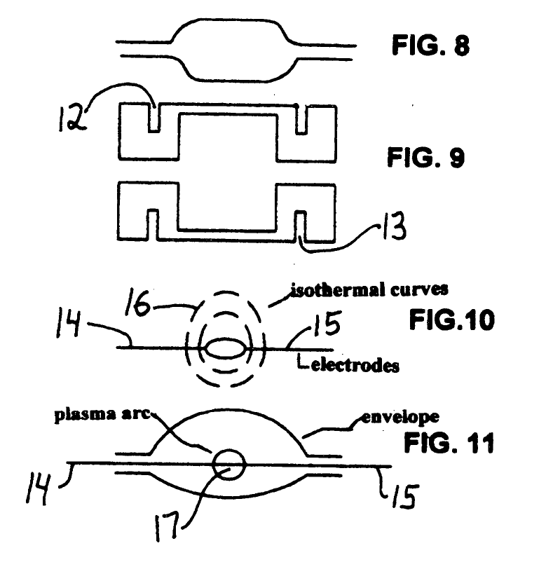

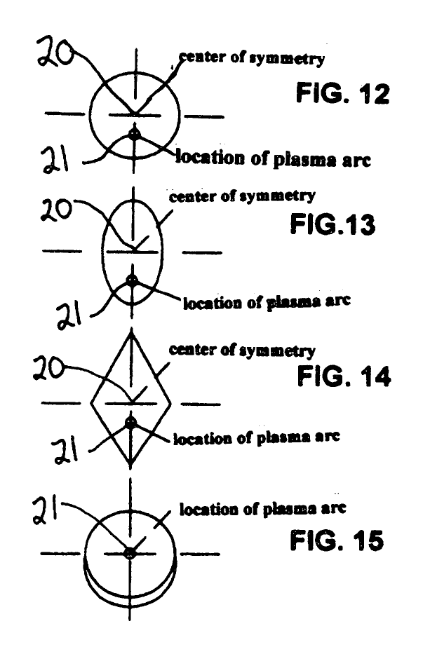

Burner design must also account for the convection effect inside the lamp bulb. In a paper presented at the SPIE conference on Lamp modeling and Characterization (SPIE Vol. 4775, 2002) Giese et al describe how most of the heat flux from the plasma arc finds its way to the top of the burner bulb. I fused silica vessels this creates a major problem since the bottom of the burner needs to be hot enough to sustain the desired mercury vapor pressure and the top of the burner needs to be cool enough so that it will not induce crystallization on the inner surface of the bulb. In the case of SCA burners, a much larger temperature variation between the top and the bottom of the burner bulb can be tolerated because SCA is a functional material for lamp purposes up to temperatures of 1600° C. whereas fused silica can tolerated temperatures of up to about 1100° C. This invention includes shapes of the burner that will influence the effect of convection and the temperature distribution inside the burner. The designs shown may be of more critical influence for fused silica burners rather than SCA burners. One approach is to determine the isotherms formed by the arc discharge and design a burner bulb that follows the isotherm outline so as to maintain an even temperature over the bulb surface area. FIG. 10 depicts a theoretical convection pattern for a plasma arc with isotherm curves 16 drawn in. FIG. 11 shows a bulb geometry that follows the isotherm curve indications. The arc 17 is positioned off center in the burner bulb in order to be closer to the bottom and further away from the top. This approach gives rise to asymmetric arc lamps, where the position of the arc is not along the axis of symmetry of the bulb. A number of such variations are given in FIGS. 12, 13 and 14. These figures \depict cross sections of burners vertical to the axis of the arc. In all of these depictions the basic approach is to determine and follow the isotherm mapping for a particular arc and locate the plasma arc 21 off the axis of symmetry 20 where it will best adapt to the isotherm curves. This process may be iterative in modeling, since the presence of the burner will effect the isotherm distribution that exists without the burner's presence.

Another approach to compensating for the effects of convection is the use of asymmetric wall thickness for the burner. The Delta T between the outer wall temperature and the inner wall temperature was given by Equation 5. A design where the wall thickness was larger for the bottom part of the burner would yield a higher temperature on the inside surface of the bottom than on the inside of the top, since the outside surface temperature would be approximately equal for the entire outside burner surface. With this approach one could reduce the variation in temperature between the bottom and top of the burner. Again, this design approach applies to fused silica as well as SCA envelopes. The results will be more dramatic with fused silica envelopes because there, due to the high emissivity of that material, the difference in temperature between inside and outside walls is in the range of 100-150° C., whereas for SCA the Delta T is in the range of 20-35° C. because of the moderate emissivity of SCA. FIG. 15 shows an example of variable wall thickness in a burner with cylindrical cross section and the plasma arc located on the axis of symmetry of the vessel. It is clear that a designer of burner bulbs can use both the wall thickness variation and the asymmetric location of the plasma arc to design a burner with the appropriate temperature distribution on the envelope and desirable convection pattern inside the burner.

V. Color

Typically, most professional and consumer applications in image projection gravitate to a color temperature of 8,000° K because this color has been found more pleasing by audiences watching images displayed in darkened rooms. This may be due to the fact that in the dark, the scotopic vision peak shifts toward the blue while in broad daylight the D₆₅ Standard at 6500° K has the best color rendering index. The mercury spectrum at low pressures is composed by a number of lines. As the pressure is increased, these lines broaden and substantial continuum radiation is generated through free-free collisions in the plasma. The higher the electron density is the more continuum radiation is generated. Ideally, if a black body spectrum could be generated, one would like the RBG color bands to be limited by the black body boundaries at their respective wavelengths at a temperature of 8,000° K. This way one could achieve a perfect match between the RGB colors and the highest color efficiency possible, about 85%. Some 15% of the visible spectrum is not included in the RGB bands.

In a paper presented at SID 2003 by Holger Moench of Philips experimental data is shown to support the need for better color matching in future HID lamps for projection. The goal is to match the color gamut indicated by the SMPTE color standard. Experiments show that UHP mercury lamps have shown color efficiency improvements of 15% per 100 bar increase in pressure up to the point where the pressure is high enough and the power per unit gap length is high enough to get the arc plasma to emit radiation close to the black body limit at 8,000° K. To achieve maximum color efficiency it is necessary to go to pressures at or above 300 bar and power loads in the vicinity of 300 watts per mm gap. State of the art UHP lamps now manufactured by Philips can operate up to a pressure of 250 bar and power loads of about 200 W per gap mm. Such operation is considered at this time to be at the limit of the fused silica envelopes used and that no further improvements can be achieved in lamp performance unless the envelope material is upgraded by use of SCA. Part of this invention is to claim lamp operating regimes where color efficiency can be maximized. Such operating regimes will have a major impact on small gap (0.5-0.7 mm) mercury arc lamps that are important for future applications of light valves in the 0.5″ diagonal size.

1. A short arc HID (High Intensity Discharge) lamp comprising:
a lamp container vessel having an inner wall and an outside wall surface, the vessel being of SCA (Single Crystal Alumina);
a plurality of electrodes within the vessel and positioned to subtend an arc gap between them which gap defines a discharge path, the arc gap being in the range of 0.5-0.7 mm;
the lamp vessel being of monolithic structure and bulbous in shape;
the lamp vessel fabricated and finished so it is has a minimum tensile strength of 50 k psi at 1200° C.;
a mercury fill within the vessel in the range of 0.40-0.75 mg/mm³;
wherein in operation, the vessel has a minimum wall temperature on the inner wall of the vessel selected from one of the group: 1060° C. to 1117° C. at a mercury fill in the range of 0.40-0.50 mg/mm³; a minimum wall temperature on the inner wall of the vessel of 1117° C. to 1156° C. at a mercury fill in the range of 0.50-0.60 mg/mm³; a minimum wall temperature on the inner wall of the vessel of 1156° C. to 1197° C. at a mercury fill in the range of 0.60-0.70 mg/mm³ and a minimum wall temperature on the inner wall of the vessel of 1197° C. to 1220° C. at a mercury fill of 0.70-0.75 mg/mm^{3.}

2. An HID lamp as in claim 1 wherein the lamp is operated with a nominal arc voltage range of 65-130 volts and a nominal lamp voltage in the range of 83-148 volts.

3. An HID lamp as in claim 1 wherein the lamp is operated with a power density in the range of 200-300 watts per mm arc gap.

4. An HID lamp as in claim 1 wherein the lamp is operated with lamp power in the range of 100-210 wafts.

5. An HID lamp as in claim 1 wherein the lamp has a maximum outside wall surface area in the range of 5-8 cm² and a minimum outside wall area of 2.4 cm² when operated at lamp power of at least 100 watts.

6. An HID lamp as in claim 1 wherein the lamp has a maximum outside wall surface area in the range of 10-15 cm² and a minimum outside wall surface of 4.8 cm² when operated at lamp power of at least 200 watts.

7. An HID lamp as in claim 1 wherein the lamp is operated at a correlated color temperature in the range of 6500-8,000° K and color efficiency of over 80%.

8. An HID lamp as in claim 1 wherein the lamp is filled with an appropriate halogen fill for the purpose of introducing a regenerative chemical cycle to the discharge chamber.

9. A short arc HID (High Intensity Discharge) lamp comprising:
a lamp container vessel having an inner wall and an outside wall surface, the vessel being of SCA (Single Crystal Alumina);
a plurality of electrodes within the vessel and positioned to subtend an arc gap between them which gap defines a discharge path, the arc gap being in the range of 0.7-0.9 mm;
the lamp vessel being of monolithic structure and bulbous in shape;
the lamp vessel fabricated and finished so it is has a minimum tensile strength of 50 k psi at 1200° C.;
a mercury fill within the vessel in the range of 0.40-0.75 mg/mm³;
wherein in operation, the vessel has a minimum wall temperature on the inner wall of the vessel selected from one of the group: 1060° C. to 1117° C. at a mercury fill in the range of 0.40-0.50 mg/mm³; a minimum wall temperature on the inner wall of the vessel of 1117° C. to 1156° C. at a mercury fill in the range of 0.50-0.60 mg/mm³; a minimum wall temperature on the inner wall of the vessel of 1156° C. to 1197° C. at a mercury fill in the range of 0.60-0.70 mg/mm³ and a minimum wall temperature on the inner wall of the vessel of 1197° C. to 1220° C. at a mercury fill of 0.70-0.75 mg/mm^{3.}

10. An HID lamp as in claim 9 wherein the lamp is operated with a nominal arc voltage range of 73-175 volts and a nominal lamp voltage in the range of 91-193 volts.

11. An HID lamp as in claim 9 wherein the lamp is operated with a power density in the range of 200-300 watts per mm arc gap.

12. An HID lamp as in claim 9 wherein the lamp is operated with lamp power in the range of 140-335 watts.

13. An HID lamp as in claim 9 wherein the lamp has a maximum outside wall surface area in the range of 10-15 cm² and a minimum outside wall area of 4.8 cm² when operated at lamp power of at least 200 watts.

14. An HID lamp as in claim 9 wherein the lamp has a maximum outside wall surface area in the range of 15-23 cm² and a minimum outside wall surface of 7.2 cm² when operated at lamp power of at least 300 watts.

15. An HID lamp as in claim 9 wherein the lamp is operated at a correlated color temperature in the range of 6500-8,000° K and color efficiency of over 80%.

16. An HID lamp as in claim 9 wherein the lamp is filled with an appropriate halogen fill for the purpose of introducing a regenerative chemical cycle in the discharge chamber.

17. A short arc HID (High Intensity Discharge) lamp comprising:
a lamp container vessel having an inner wall and an outside wall surface, the vessel being of SCA (Single Crystal Alumina);
a plurality of electrodes within the vessel and positioned to subtend an arc gap between them which gap defines a discharge path, the arc gap being in the range of 0.9-1.1 mm;
the lamp vessel being of monolithic structure and bulbous in shape;
the lamp vessel fabricated and finished so it has a minimum tensile strength of 50 k psi at 1200° C.;
a mercury fill within the vessel in the range of 0.30-0.75 mg/mm³;
wherein in operation, the vessel has a minimum wall temperature on the inner wall of the vessel selected from one of the group: 993° C. to 1060° C. at a mercury fill in the range of 0.30-0.40 mg/mm³; a minimum wall temperature on the inner wall of the vessel of 1060° C. to 1117° C. at a mercury fill in the range of 0.50-0.60 mg/mm³; a minimum wall temperature on the inner wall of the vessel of 1117° C. to 1197° C. at a mercury fill in the range of 0.60-0.70 mg/mm³ and a minimum wall temperature on the inner wall of the vessel of 1197° C. to 1220° C. at a mercury fill of 0.70-0.75 mg/mm^{3.}

18. An HID lamp as in claim 17 wherein the lamp is operated with a nominal arc voltage range of 70-200 volts and a nominal lamp voltage in the range of 88-218 volts.

19. An HID lamp as in claim 17 wherein the lamp is operated with a power density in the range of 200-350 watts per mm arc gap.

20. An HID lamp as in claim 17 wherein the lamp is operated with lamp power in the range of 180-400 watts.

21. An HID lamp as in claim 17 wherein the lamp has a maximum outside wall surface area in the range of 10-18 cm² and a minimum outside wall area of 4.8 cm² when operated at lamp power of at least 200 watts.

22. An HID lamp as in claim 17 wherein the lamp has a maximum outside wall surface area in the range of 15-28 and a minimum outside surface area of 7.2 cm² when operated at lamp power of at least 300 watts.

23. An HID lamp as in claim 17 wherein the lamp has a maximum outside wall surface area in the range of 20-30 cm² and a minimum outside surface area of 9.6 cm² when operated at lamp power of 400 watts.

24. An HID lamp as in claim 17 wherein the lamp is filled with an appropriate halogen fill for the purpose of introducing a regenerative chemical cycle in the discharge chamber.

25. An HID lamp as in claim 17 wherein the lamp is operated at a correlated color temperature range of about 6,500-8,000° K and color efficiency of over 80%.

26. A short arc HID (High Intensity Discharge) lamp comprising:
a lamp container vessel having an inner wall and an outside wall surface, the vessel being of SCA (Single Crystal Alumina);
a plurality of electrodes within the vessel and positioned to subtend an arc gap between them which gap defines a discharge path, the arc gap being in the range of 1.1-1.3 mm;
the lamp vessel being of monolithic structure and bulbous in shape;
the lamp vessel fabricated and finished so it has a minimum tensile strength of 50 k psi at 1200° C.;
a mercury fill within the vessel in the range of 0.30-0.75 mg/mm³;
wherein in operation, the vessel has a minimum wall temperature on the inner wall of the vessel selected from one of the group: 993° C. to 1060° C. at a mercury fill in the range of 0.30-0.40 mg/mm³; a minimum wall temperature on the inner wall of the vessel of 1060° C. to 1117° C. at a mercury fill in the range of 0.50-0.60 mg/mm³; a minimum wall temperature on the inner wall of the vessel of 1117° C. to 1197° C. at a mercury fill in the range of 0.60-0.70 mg/mm³ and a minimum wall temperature on the inner wall of the vessel of 1197° C. to 1220° C. at a mercury fill of 0.70-0.75 mg/mm^{3.}

27. An HID lamp as in claim 26 wherein the lamp is operated with a nominal arc voltage range of 86-254 volts and a nominal lamp voltage in the range of 104-272 volts.

28. An HID lamp as in claim 26 wherein the lamp is operated with a power density in the range of 175-325 watts per mm arc gap.

29. An HID lamp as in claim 26 wherein the lamp is operated with lamp power in the range of 193-423 watts.

30. An HID lamp as in claim 26 wherein the lamp has a maximum outside wall surface area in the range of 10-18 cm² and a minimum outside wall area of 4.8 cm² when operated at lamp power of at least 200 watts.

31. An HID lamp as in claim 26 wherein the lamp has a maximum outside wall surface area in the range of 15-28 and a minimum outside surface area of 7.2 cm² when operated at lamp power of at least 300 watts.

32. An HID lamp as in claim 26 wherein the lamp has a maximum outside wall surface area in the range of 20-30 cm² and a minimum outside surface area of 9.6 cm² when operated at lamp power of 400 watts.

33. An HID lamp as in claim 26 wherein the lamp is filled with an appropriate halogen fill for the purpose of introducing a regenerative chemical cycle in the discharge chamber.

34. An HID lamp as in claim 26 wherein the lamp is operated at a correlated color temperature range of about 6,500-8,000° K and color efficiency of over 80%.

35. A short arc HID (High Intensity Discharge) lamp comprising:
a lamp container vessel having an inner wall and an outside wall surface, the vessel being of SCA (Single Crystal Alumina);
a plurality of electrodes within the vessel and positioned to subtend an arc gap between them which gap defines a discharge path, the arc gap being in the range of 1.3-1.5 mm;
the lamp vessel being of monolithic structure and bulbous in shape;
the lamp vessel fabricated and finished so it has a minimum tensile strength of 50 k psi at 1200° C.;
a mercury fill within the vessel in the range of 0.30-0.75 mg/mm³;
wherein in operation, the vessel has a minimum wall temperature on the inner wall of the vessel selected from one of the group: 993° C. to 1060° C. at a mercury fill in the range of 0.30-0.40 mg/mm³; a minimum wall temperature on the inner wall of the vessel of 1060° C. to 1117° C. at a mercury fill in the range of 0.40-0.50 mg/mm³; a minimum wall temperature on the inner wall of the vessel of 1117° C. to 1197° C. at a mercury fill in the range of 0.50-0.70 mg/mm³ and a minimum wall temperature on the inner wall of the vessel of 1197° C. to 1220° C. at a mercury fill of 0.70-0.75 mg/mm^{3.}

36. An HID lamp as in claim 35 wherein the lamp is operated with a nominal arc voltage range of 104-292 volts and a nominal lamp voltage in the range of 119-310 volts.

37. An HID lamp as in claim 35 wherein the lamp is operated with a power density in the range of 160-300 watts per mm arc gap.

38. An HID lamp as in claim 35 wherein the lamp is operated with lamp power in the range of 208-450 watts.

39. An HID lamp as in claim 35 wherein the lamp has a maximum outside wall surface area in the range of 10-18 cm² and a minimum outside wall area of 4.8 cm² when operated at lamp power of 200 watts.

40. An HID lamp as in claim 35 wherein the lamp has a maximum outside wall surface area in the range of 15-28 and a minimum outside surface area of 7.2 cm² when operated at lamp power of at least 300 watts.

41. An HID lamp as in claim 35 wherein the lamp has a maximum outside wall surface area in the range of 20-30 cm² and a minimum outside surface area of 9.6 cm² when operated at lamp power of at least 400 watts.

42. An HID lamp as in claim 35 wherein the lamp is filled with an appropriate halogen fill for the purpose of introducing a regenerative chemical cycle in the discharge chamber.

43. An HID lamp as in claim 35 wherein the lamp is operated at a correlated color temperature range of about 6,500-8,000° K and color efficiency of over 80%.

44. A short arc HID (High Intensity Discharge) lamp as in claims 1, 9, 17, 24 or 35 wherein the lamp container vessel has a top wall which is toward the sky in normal operating position of the lamp and a bottom wall which is toward the earth in said normal operating position (horizontal), the vessel being asymmetric in form, with the bottom wall being thicker than the top wall.

45. A short arc HID (High Intensity Discharge) lamp as in claims 1, 9, 17, 24 or 35
wherein the lamp container vessel has a top wall dome which is toward the sky in normal operating position (horizontal) of the lamp and a bottom wall dome which is toward the earth in said normal operating position;
the vessel being asymmetric in form, with the top wall dome being larger than the bottom wall dome, resulting in the discharge arc being closer to the bottom wall.

46. A short arc HID (High Intensity Discharge) lamp as in claims 1, 9, 17, 24 or 35 wherein the lamp container vessel has a top wall which is toward the sky in normal operating position (horizontal) of the lamp and a bottom wall which is toward the earth in said normal operating position;
the vessel having an imaginary central axis; and wherein
the arc gap is located asymmetric to the vessel by not being positioned along the central axis and being positioned closer to the bottom wall than to the top wall.
